(19) United States
(12) Patent Application Publication
(10) Pub. No.: US 2012/0044446 A1
(43) Pub. Date: Feb. 23, 2012

(54) LIQUID CRYSTAL DISPLAY DEVICE AND METHOD FOR PRODUCING SAME

(75) Inventors: Yoshihito Hara, Osaka-shi (JP); Yukinobu Nakata, Osaka-shi (JP); Keizoh Watanabe, Osaka-shi (JP)

(73) Assignee: SHARP KABUSHIKI KAISHA, Osaka-shi, Osaka (JP)

(21) Appl. No.: 13/265,924

(22) PCT Filed: Jan. 20, 2010
(86) PCT No.: PCT/JP2010/050621

§ 371 Date: Oct. 24, 2011

(30) Foreign Application Priority Data
May 13, 2009 (JP) 2009-116787

(51) Int. Cl. G02F 1/1343; H01J 9/24

(52) U.S. Cl. 349/139; 445/24

(57) ABSTRACT

The present invention provides: a vertical alignment liquid crystal display device using comb electrodes for voltage application to liquid crystals, the device being capable of reducing alignment defects of liquid crystals occurring at tips of electrodes, having a high contrast and white brightness, and being excellent in display properties; and a method for producing the same. The present invention is a method for producing a liquid crystal display device comprising a pair of substrates, a liquid crystal layer between the substrates, and an electrode for voltage application in the liquid crystal layer, the method comprising the steps of: resist pattern formation in which a resist film formed on a conductive film is exposed through a photomask; and an electrode pattern formation in which the conductive film is etched through the resist pattern, the photomask having a light-shielding or light-transmitting pattern including a core portion and a plurality of branch portions extending from the core portion, the branch portions each having a wide part at the tip.

### TECHNICAL FIELD

The present invention relates to a liquid crystal display device and a method for producing the same. More specifically, the present invention relates to a vertical alignment liquid crystal display device in which a voltage is applied to liquid crystals through a comb electrode, and a method for producing the same.

### BACKGROUND ART

Liquid crystal display devices have advantageous features, such as thin profile, light weight, and low power consumption, which allow their wide use in various fields. Among a variety of display modes used in the liquid crystal display devices, the VA (Vertical alignment) mode is known as a mode realizing a high contrast ratio in liquid crystal display devices.

Among VA-mode liquid crystal display devices, multi-domain vertical alignment liquid crystal display devices (hereinafter, referred to as MVA-LCD) are known to allow easy control of the alignment direction of liquid crystals, in which liquid crystals having negative dielectric anisotropy are vertically aligned and an electrode notch (slit) or the like is provided as an alignment-control structure (see Patent Document 1).

In MVA-LCDs, one known configuration in which an electrode notch (slit) is provided is a comb electrode commonly referred to as Line and Space (see Patent Document 2). In comb electrodes, it is important that the intervals between adjacent electrodes are constant. Such a configuration allows alignment control of liquid crystals in a predetermined direction.
[Patent Document 1]Japanese Kokai Publication No. 2003-149647 (JP-A 2003-149647)
[Patent Document 2]Japanese Kokai Publication No. 2006-330375 (JP-A 2006-330375)

### DISCLOSURE OF INVENTION

### Problems to Be Solved by the Invention

However, it is difficult to maintain constant intervals between adjacent electrodes in production of comb electrodes. This is due to the formation process described below. Comb electrodes are formed by a combination treatment of exposure and etching. Specifically, a conductive film (electrode film) is formed first, and a resist film is provided on the conductive film. The resist film is exposed and developed through a photomask so that a resist pattern having a desired pattern is formed. Next, the conductive film is etched using the resist pattern as a mask. In this manner an electrode pattern in a desired form is obtained.

Since the electrode pattern of comb electrodes has linear sides, the sides are well exposed. However, the tips of the electrode pattern have a corner, which may cause a diffraction defect during the exposure. As a result, the obtained electrode has round tapered tips. Especially, in the case of a narrow pattern width, such a tendency becomes more prominent. Even when a diffraction defect is avoided, sharp corners are not easily formed at tips of the electrode in the subsequent etching. After all, the obtained electrode has round tapered tips.

When the electrode has round tapered tips, the interval between the electrodes is wider at a tip part than at a central part. This may easily cause an alignment defect of liquid crystals in this part. This lowers the light transmittance of the obtained liquid crystal display device because a non-light-transmitting region may be formed around the tips of the branch portions of the electrode. In addition, the alignment defect of liquid crystals may narrow the view angle or lower the response speed. Therefore, further improvement in display properties has been desired.

The present invention has been devised in consideration of the present situation and an object thereof is to provide a liquid crystal display device having excellent display properties owing to reduction in alignment defects of liquid crystals which may occur around the tips of a comb electrode in a vertical alignment liquid crystal display device using the comb electrode for voltage application to liquid crystals, and a method for producing the same.

### Means for Solving the Problems

The present inventors have made intensive studies on vertical alignment liquid crystal display devices using comb electrodes for voltage application to liquid crystals to find out that alignment defects of liquid crystals occurring around the tips of electrodes are caused by a round tapered shape of the tips. Then, the present inventors have further found out that such a shape is caused by exposure and etching in formation of electrodes. By configuring a mask pattern used in exposure to be able to correct the tip shape of the electrode, tapered round shape of the tips in the resist pattern is moderated. Also in etching using the resist pattern, formation of the round tapered tips of the electrode can be reduced. This reduces the alignment defect of liquid crystals to allow production of liquid crystal display devices having excellent display properties. Consequently, the present inventors solved the above problems and completed the present invention.

Namely, the present invention is a method for producing a liquid crystal display device comprising a pair of substrates, a liquid crystal layer between the substrates, and an electrode for voltage application in the liquid crystal layer, the method comprising the steps of: resist pattern formation in which a resist film formed on a conductive film is exposed through a photomask; and an electrode pattern formation in which the conductive film is etched through the resist pattern, the photomask having a light-shielding or light-transmitting pattern including a core portion and a plurality of branch portions extending from the core portion, the branch portions each having a wide part at the tip.

In the method for producing a liquid crystal display device according to the present invention, comb electrodes are formed in vertical alignment crystal display devices. The comb electrodes are formed by performing the following steps. First, a conductive film and a resist film are formed on a supporting substrate such as a glass substrate and a resin substrate and the resist film is exposed and developed so that a resist pattern is formed. Then, an electrode pattern is formed by etching using the obtained resist pattern as a mask.

Examples of the conductive film include a transparent conductive film, a reflective conductive film, and a lamination comprising a transparent conductive film and a reflective conductive film. More specifically, the transparent conductive film may be a film made of a conductive material having high light transmittance such as indium tin oxide (ITO), indium zinc oxide (IZO) and zinc oxide. The reflective conductive film may be a film made of a conductive material having high light reflectance such as aluminum (Al), silver (Ag), chromium (Cr), iron (Fe), cobalt (Co), nickel (Ni), copper (Cu), tantalum (Ta), tungsten (W), Platinum (Pt), and Gold (Au), and a film made of an alloy of these.

The photomask used in exposure performed in the resist pattern formation step has a light-shielding or light-transmitting pattern including a core portion and a plurality of branch portions extending from the core portion to form comb electrodes. In the present invention, the branch portions each have a wide part at the tip.

In the case that exposure is performed using a photomask having branch portions each with a wide part at the tip as described above, even if tips of the branch portions of the resist pattern are round tapered by a diffraction defect, the degree of roundness and tapering is moderated by the wide parts. Accordingly, it is possible to avoid a case where the tips of the branch portions of the resist pattern have an extremely smaller width compared to the branch portions, more specifically, a central part of the branch portions.

In the electrode pattern formation step, etching is performed using a resist pattern having branch portions without tips which are significantly round tapered, and therefore, the electrode pattern obtained is allowed to have a favorable pattern. Here, etching may be dry etching or wet etching.

Even if the tips of the branch portions of the electrode pattern are rounded during etching, the influence caused by this is smaller compared to the case where etching is performed using a resist pattern having round tapered tips.

Accordingly, in the present invention, tapering and roundness of the tips of the branch portions are moderated so that fine liquid crystal alignment is achieved around the tips. Asa result, excellent display properties are realized. Here, the resist pattern is removed by asking after etching.

The configuration of the liquid crystal display device of the present invention is not especially limited as long as it essentially includes such components. The liquid crystal display device may or may not include other components.

The photomask of the present invention preferably has the wide parts each having a larger width than the interval between the branch portions adjacent to each other. The reason for this is that, since the space between the adjacent branch portions is shaded, smaller space between the adjacent branch portions is preferable to increase the light transmittance.

The wide part of the photomask preferably has a larger area than the tip of a branch portion of the electrode obtained through the electrode pattern formation. Such a configuration surely moderates roundness and tapering of the tips of the branch portions of the resist pattern, resulting in better liquid crystal alignment.

A more preferable embodiment of the present invention is that the photomask has a light-shielding or light-transmitting pattern including a cross-shaped core portion dividing each pixel into four domains and a plurality of branch portions extending obliquely from the core portion in each of the four domains, when seen in a normal direction of the mask face, and an angle formed by a virtual line along the tips of the plurality of branch portions on a pixel boundary side and a short edge of the tips is within a range of 0° to 30°.

An electrode obtained in the above embodiment has a pattern including a cross-shaped core portion dividing each pixel into four domains and a plurality of branch portions extending obliquely from the core portion in each of the four domains. Four domains of each pixel divided by the electrode allows uniform alignment of liquid crystals to achieve a wide view angle. In addition, an alignment defect of liquid crystals is less likely to occur around the tips of the branch portions of the electrode. This further improves the view angle, accelerates the response speed and achieves fine γ characteristics. Consequently, it is possible to realize a liquid crystal display device excellent in various display properties.

In the above embodiment, from the standpoint of pattern formation and the liquid crystal alignment, the wide part is preferably positioned within a range of 0.5 to 3 μm from an intersection between the virtual line along the tips on the pixel boundary side and an extended line of a long edge of one of the branch portions.

The present invention also provides a liquid crystal display device comprising a first substrate, a liquid crystal layer, and a second substrate in this order, wherein the first substrate includes a pixel electrode having a core portion and a plurality of branch portions extending from the core portion, the pixel electrode is for applying a voltage to the liquid crystal layer, and, an interval between the branch portions adjacent to each other at a tip part is substantially the same as or narrower than the interval at a central part of the branch portions, or the tips are combined with each other. In the liquid crystal display device according to the present invention, the interval between the adjacent branch portions at a tip part is substantially the same as or narrower than the interval at a central part of the branch portions. Therefore, the alignment defect of liquid crystals at the tips of the branch portions can be reduced so that formation of a non-light-transmitting region is suppressed. Accordingly, lowering of the light transmittance can be avoided. In addition, even when the adjacent tips are combined with each other, the alignment defect of liquid crystals can be reduced compared to the case where the tips of the branch portions have a round tapered shape. Consequently, it is possible to realize a liquid crystal display device excellent in display properties.

The liquid crystal display device of the present invention conducts displays by changing the retardation of the liquid crystal layer through changing the voltage applied to the liquid crystal layer. More specifically, the liquid crystal display device of the present invention is a vertical alignment liquid crystal display device in which the alignment of liquid crystals is controlled by comb pixel electrodes. The vertical alignment (VA mode) is a display mode in which a negative liquid crystals having negative dielectric anisotropy are used, and the liquid crystals are aligned substantially vertically to the substrate face when the voltage smaller than a threshold voltage is applied (e.g. no voltage applied) and tilt substantially horizontally to the substrate face when the voltage not smaller than a threshold voltage is applied. The liquid crystal molecules having negative dielectric anisotropy refers to liquid crystal molecules having a dielectric constant larger in the long axis direction than in the short axis direction.

The pixel electrode is commonly provided in each pixel and used for voltage application to the liquid crystal layer. A preferable embodiment of the pixel electrode is an embodiment in which a cross-shaped core portion divides each pixel into four domains and a plurality of branch portions are extending from the core portion in each of the four domains. When the cross-shaped core portion extends in directions forming angles of 0°, 90°, 180°, and 270°, from the standpoint of improving the view angle properties, the four domains preferably include a domain where the branch portions are extending in a direction at an angle of 45°, a domain where the branch portions are extending in a direction at an angle of 135°, a domain where the branch portions are extending in a direction at an angle of 225°, and a domain where the branch portions are extending in a direction at an angle of 315°.

The liquid crystal display device of the present invention has a display region including a region where branch portions and slits (part where no pixel electrode is formed) are alternately arranged. In the case that pixel electrodes are an only means to control liquid crystal alignment and no means to control liquid crystal alignment is provided on a substrate opposing the substrate where the pixel electrodes are formed, the width of the central part of each branch portion of the pixel electrode is preferably not more than 4 μm and the width of the central part of each slit is also preferably not more than 4 μm, from the standpoint of stabilization of the liquid crystal alignment.

The region where the core portion of the pixel electrode is arranged is preferably used as a reflective region. For example, in an embodiment where a cross-shaped core portion divides a pixel into four domains and a plurality of branch portions are extending in each of the four domains, alignment directions of liquid crystals are different from each other in four domains and the region where the core portion is arranged serves as a boundary of different alignments. Accordingly, in the region where the core portion is arranged, the alignment of liquid crystals are not easily stabilized, which may be a cause of display roughness. Commonly, a reflective display is not designed based on such a high display quality as that of the transmission display. Therefore, it is possible to diminish the influence to the display quality even when the core portion is used as a reflective region without being shaded. As a result, the aperture ratio is improved.

The above embodiments may be employed in combination without departing from the present invention.

### Effect of the Invention

According to the method for producing a liquid crystal display device of the present invention, a photomask having a pattern correcting the shape of tips of branch portions is used in pattern formation of a pixel electrode. As a result, a comb electrode in which an alignment defect of liquid crystals is less likely to occur around the tip portions can be obtained. Such a comb electrode may be an electrode in which the interval between the adjacent branch portions at a tip part is substantially the same as or narrower than the interval at a central part of the branch portions, or the tips are combined with each other. These electrodes make it possible to reduce alignment defects of liquid crystals in the liquid crystal display device. Therefore, excellent display properties can be realized.

### BRIEF DESCRIPTION OF DRAWINGS

FIG. 1 is a schematic plan view illustrating a configuration of a first substrate of a liquid crystal display device according to Embodiment 1.

FIG. 2 is an enlarged schematic plan view illustrating a principal part of a pixel electrode shown in FIG. 1.

FIG. 3 is a schematic cross-sectional view illustrating a configuration of the liquid crystal display device taken along A-B line in FIG. 1.

FIGS. 4(a) to 4(d) are schematic cross-sectional views each illustrating a step for producing the first substrate according to Embodiment 1.

FIG. 5(a) is a schematic plan view of a photomask according to Embodiment 1. FIG. 5(b) is an enlarged schematic plan view illustrating a principal part of the photomask shown in FIG. 5 (a). FIG. 5(c) is an enlarged schematic plan view illustrating a branch portion of the photomask. FIG. 5(d) is an enlarged schematic plan view illustrating a tip of a branch portion of a pixel electrode. FIG. 5(e) is an enlarged schematic plan view illustrating a tip of a resist pattern.

FIGS. 6(a) to 6(c) are enlarged schematic views each illustrating a principal part of another embodiment of a mask pattern according to Embodiment 1.

FIG. 7(a) is a schematic plan view of a pixel electrode according to Embodiment 2. FIG. 7(b) is a schematic plan view of a photomask. FIG. 7(c) is a schematic plan view illustrating the liquid crystal display device in an ON state.

FIG. 8(a) is a schematic plan view of the pixel electrode according to Embodiment 2. FIG. 8(b) is an enlarged schematic plan view illustrating a principal part of the pixel electrode shown in FIG. 8(a).

FIG. 9 is a schematic plan view illustrating the liquid crystal display device according to Embodiment 1 in an ON state.

FIG. 10(a) is a schematic plan view of a photomask according to Comparative Example 1. FIG. 10 (b) is an enlarged schematic plan view illustrating a principal part of the photomask.

FIG. 11(a) is a schematic plan view of a resist pattern according to Comparative Example 1. FIG. 11(b) is an enlarged schematic plan view of a principal part of the resist pattern. FIG. 11(c) is a schematic plan view illustrating the liquid crystal display device in an ON state.

FIG. 12 is a graph showing transmittance of Example 1 and Comparative Example 1.

### MODES FOR CARRYING OUT THE INVENTION

The present invention will be mentioned in more detail referring to the drawings in the following embodiments, but is not limited to these embodiments.

### Embodiment 1

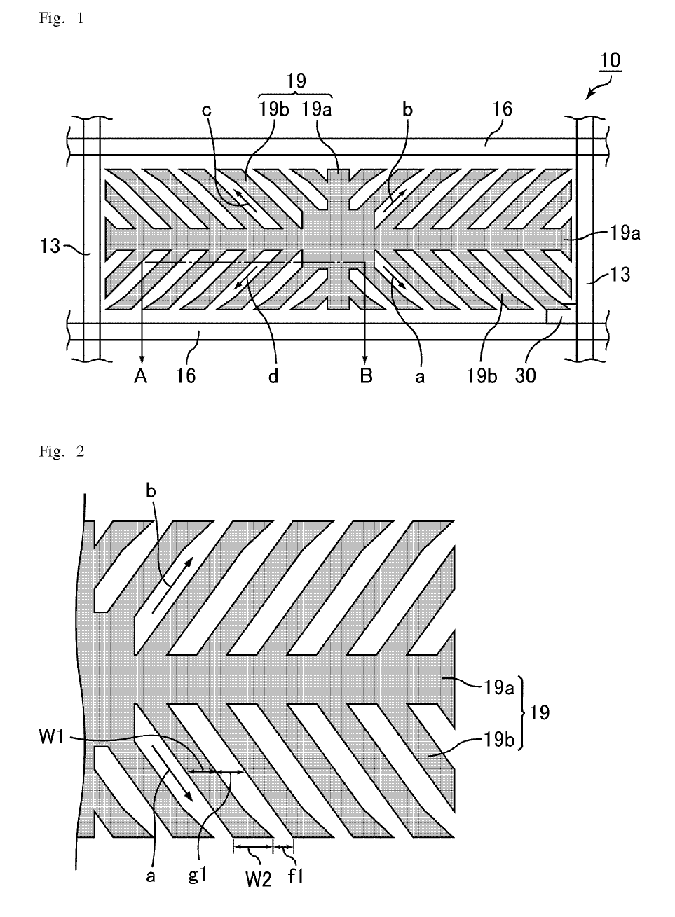

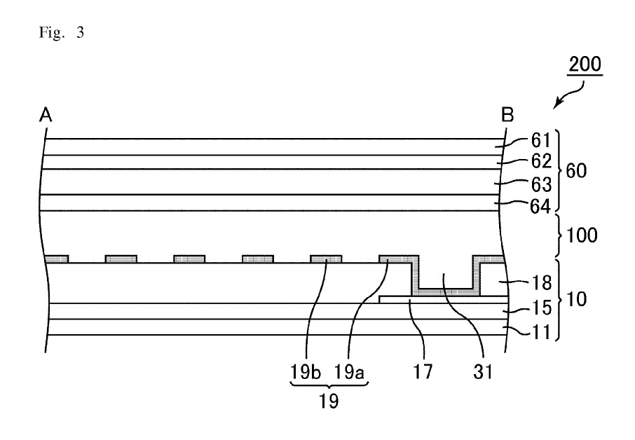

The present embodiment is described referring to a vertical alignment liquid crystal display device provided with a comb electrode. FIG. 1 is a schematic plan view illustrating a configuration of a first substrate of a liquid crystal display device according to the present embodiment. FIG. 2 is an enlarged schematic plan view illustrating a principal part of a pixel electrode shown in FIG. 1. FIG. 3 is a schematic cross-sectional view illustrating a configuration of the liquid crystal display device taken along A-B line in FIG. 1.

In FIGS. 1 to 3, a liquid crystal display device 200 according to the present embodiment is provided with a first substrate 10, a second substrate 60 opposing to the first substrate 10, and a liquid crystal layer 100 between the first substrate 10 and the second substrate 60.

The first substrate 10 has, on a base coat film formed on a glass substrate 11, a plurality of gate signal lines 13 running in parallel with each other, a plurality of source signal lines 16 running in parallel with each other and orthogonal to the gate signal lines 13, and thin film transistors (TFTs) 30 provided on intersections of the gate signal lines 13 and the source signal lines 16. The gate signal lines 13 are each made of a stack of TiN/Al/Ti. The source signal lines 16 are each made of a stack of Al/Ti.

The gate signal lines 13 and the source signal lines 16 are covered with a gate insulating film 15. A drain electrode 17 formed on the gate insulating film. 15 is connected to a pixel electrode 19 (19a) through a contact hole 31 formed in an interlayer insulating film 18.

The TFT 30 has a gate electrode connected to the gate signal line 13, a source electrode connected to the source signal line 16, and a drain electrode 17 electrically connected to the pixel electrode 19 through the contact hole 31.

As illustrated in FIG. 1, the pixel electrode 19 has, in each pixel, a cross-shaped core portion 19a dividing the pixel into four domains and a plurality of branch portions 19b extending toward either side from the core portion 19a. The branch portions 19b are formed so as to extend in different directions from each other in four domains divided by the core portion 19a. More specifically, when the cross-shaped core portion 19a extends in directions forming angles of 0°, 90°, 180°, and 270°, the four domains preferably include a domain where the branch portions are extending in a direction at an angle of 45°, a domain where the branch portions are extending in a direction at an angle of 135°, a domain where the branch portions are extending in a direction at an angle of 225°, and a domain where the branch portions are extending in a direction at an angle of 315°. Such a configuration aligns liquid crystals in four directions indicated by arrows “a” to “d” and allows uniform displays in a wide view angle.

The liquid crystal layer 100 is not particularly limited as long as it is used in a vertical alignment (VA mode) liquid crystal display device, and may use nematic liquid crystals having negative dielectric anisotropy. The vertical alignment may be typically realized by using a vertical alignment film (not shown) made of polyimide and the like. Liquid crystals in the liquid crystal layer 100 are aligned vertically to the surface of the alignment film formed on the first substrate 10 and the second substrate 60 on the liquid crystal layer side when no voltage is applied (OFF state). The liquid crystals tilt in a direction horizontally to the surface of the alignment film formed on the first substrate 10 and the second substrate 60 on the liquid crystal layer side when a voltage not smaller than a threshold voltage is applied (ON state).

The second substrate 60 is, for example, a color filter substrate. On the main face of a glass substrate 61, a color filter layer 62, an insulating layer 63, and a counter electrode 14 made of ITO are formed.

In the liquid crystal display device 200 as described above, though not illustrated here, polarizing elements, phase difference films, and the like are appropriately provided on the opposite side of the liquid crystal layer 100 side of the glass substrates 11 and 61. The polarizing elements may be polyvinylalcohol (PVA) films on which anisotropic materials such as iodine complex having dichroism are adsorbed and aligned.

In the present embodiment, as illustrated in FIG. 2, the branch portions 19b of the pixel electrode 19 are each formed to have a width W2 at the tip wider than a width W1 at the central part. Further, the adjacent branch portions 19b have an interval f1 at the tip narrower than the interval g1 at the central part. Such a configuration reduces an alignment defect of liquid crystals compared to the case where the branch portions 19b of the pixel electrode 19 have tapered tips. Especially, the light transmittance at the tips of the branch portions 19b can be improved.

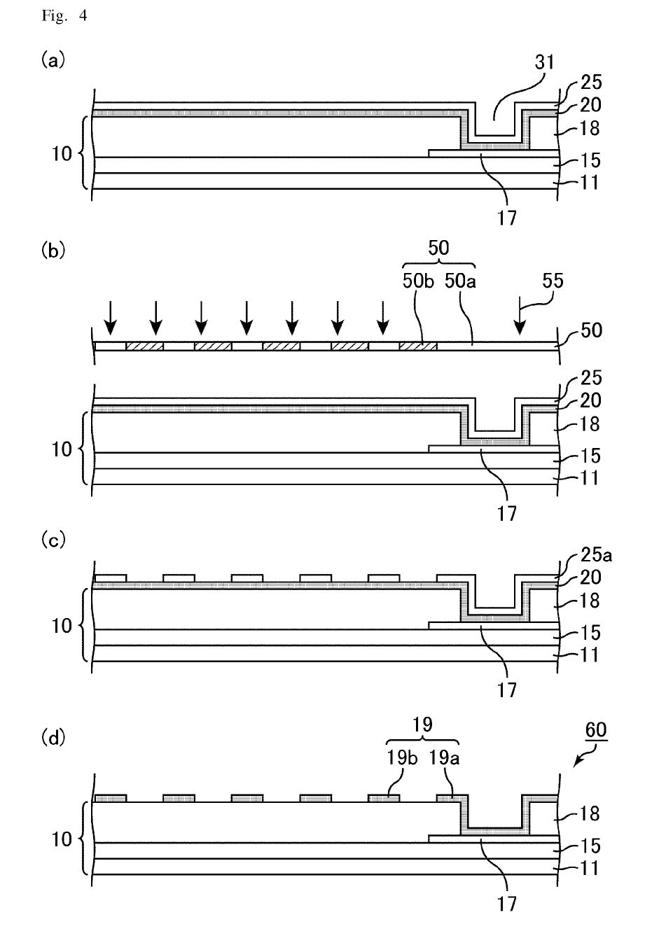

The liquid crystal display device 200 having such a configuration is produced by the following procedures. First, a method for producing the first substrate 10 is described using FIG. 4. FIGS. 4(a) to 4(d) are schematic cross-sectional views each illustrating a step for producing the first substrate according to the present embodiment.

FIG. 4(a) illustrates a state where, on a substrate for constituting the first substrate 10, a conductive film and a resist film are formed in a conductive film formation step and a resist film formation step respectively. Such a substrate is obtained by the following procedures. First, a base coat film is formed on the main face of a washed glass substrate 11. Then, various wirings such as gate signal lines 13, TFTs 30, and the like are formed thereon and covered with a gate insulating film 15. After that, a drain electrode 17 is formed. Then, the main face of the substrate is covered with an interlayer insulating film 18 and a contact hole 31 is formed in the interlayer insulating film 18.

Next, the conductive film formation step is conducted, in which a conductive film 20 is formed on the main face of the substrate having the above configuration. In the conductive film formation step, the conductive film 20 is formed to cover the entire face of the substrate, for example, by sputtering. Examples of the conductive film 20 include: a transparent conductive film made of a conductive material having a high light transmittance such as ITO, IZO, and Zinc oxide; a reflective conductive film made of a conductive material having a high light reflectance such as Al, Ag, Cr, Fe, Co, Ni, Cu, Ta, W, Pt, and Au, and an alloy of these; and a lamination of a transparent conductive film and a reflective conductive film. Subsequently, a resist film 25 is formed to cover the obtained conductive film 20. Though a negative resist film is exemplified herein, a positive resist film is also usable.

FIG. 4(b) is a schematic cross-sectional view for describing a resist pattern formation step. In FIG. 4(b), a photomask 50 is placed above the substrate on which the resist film 25 is formed. Exposure by irradiation with a light 55 is performed through the photomask 50.

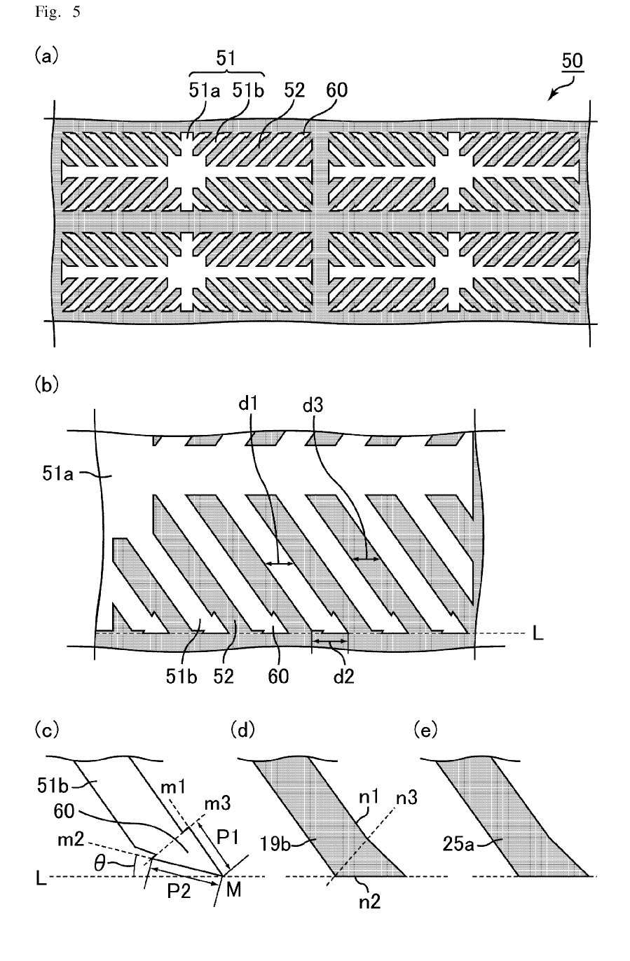

Here, the photomask 50 used in the resist pattern formation step is specifically described with reference to FIG. 5. FIG. 5(a) is a schematic plan view of the photomask 50 according to the present embodiment. FIG. 5(b) is an enlarged schematic plan view illustrating a principal part of the photomask 50 shown in FIG. 5(a). FIG. 5(c) is an enlarged schematic plan view illustrating a region surrounded by wave lines in FIG. 5(b). FIG. 5(d) is an enlarged schematic plan view illustrating a tip of a branch portion of a pixel electrode according to the present embodiment. FIG. 5(e) is an enlarged schematic plan view illustrating a tip of a resist pattern.

As illustrated in FIG. 5(a), when seen in the normal direction of the mask face, the photomask 50 has a light-transmitting portion (slit) 51 consisting of a core portion 51a dividing each pixel into four domains and a plurality of branch portions 51b arranged at predetermined angles relative to the direction orthogonal to the core portion 51a, and a light-shielding portion (slit) 52 between the branch portions 51b.

Here, as illustrated in FIGS. 5(b) and 5(c), the branch portions 51b each have a wide part 60 formed at the tip. A width d2 of the wide part 60 is wider than a width d1 at the central part of the branch portion 51b (d1<d2). Additionally, the width d2 of the wide part 60 is wider than an interval between the branch portions 51b, namely, a width d3 at the central part of the light-shielding portion 52. This is for correcting the rounding of tips of branch portions in a resist pattern that will be described later, to reduce rounded tips of the branch portions 19b of the pixel electrode 19.

The wide part 60 is set to have a larger area compared to the tip of the branch portion 19b of the pixel electrode 19. In FIG. 5(c), the area of the wide part 60 is the area surrounded by long edges m1 and m2 of the branch portion 51b and a line m3 drawn in distance P1 or P2 from the intersection M of the long edges m1 and m2. Further, in FIG. 5(d), the area of the tip of the branch portion 19b of the pixel electrode 19 is an area surrounded by a long edge n1 and a short edge n2 of the branch portion 19b and a line n3. The line n3 is a line equidistant from the intersection of the short edge n1 and the edge n2.

In the resist pattern, as illustrated in FIGS. 5(b) and 5(c), an angle θ formed by a virtual line L along the tips of the branch portions 51b and the long edge m2 is preferably within a range of 0° to 30° in order to correct round tapering of the tips of the branch portions 51b. The angle θ larger than 30° fails to achieve a sufficient correction effect because the wide part 60 becomes sharp and has a smaller area.

In the photomask 50, the width d2 of the wide part 60 is preferably larger than the interval d3 of the adjacent branch portions 51b, from the standpoint of determining the direction of the liquid crystal alignment in the pixel boundary portion which is offset from 45°, 135°, 225°, and 315°. These angles are formed by the branch portions 19b determining the liquid crystal alignment.

The wide part 60 is preferably positioned within a range of 0.5 to 3 μm from the intersection M of the virtual line along the tips of the branch portions 51b and an extended line of the long edge m1. If the wide part is positioned at a distance shorter than 0.5 μm from the intersection M, a sufficient effect of the tip correction cannot be achieved. In contrast, if the wide part is positioned at a distance longer than 3 μm from the intersection X, the tips of the obtained pixel electrode may become much larger than the desired size.

Exposure treatment is performed using the photomask 50 having the above configuration, and development treatment is subsequently performed. In this manner, a resist pattern 25a as illustrated in FIG. 4(c) is formed. Here, a tip of the resist pattern 25a has an ideal shape without being rounded, as illustrated in FIG. 5(e).

Next, an electrode pattern formation step is conducted, in which the conductive film 20 is etched through the obtained resist pattern 25a. Etching may be dry etching or wet etching. The resist pattern 25a does not have the tips of branch portions rounded as above described. Therefore, even when the tips of the branch portions of the conductive film is slightly rounded in the etching treatment, the degree thereof is small.

In this manner, a pixel electrode 19 is obtained, in which tips of the branch portions 19b are not round tapered as illustrated in FIGS. 1 and 2.

On the other hand, the second substrate 60 is obtained by the following procedures. Namely, a color filter layer 62 is formed on the main face of a glass substrate 61 and is covered with an insulating layer 63. Then, a counter electrode 64 made of ITO is formed by spattering or the like.

The first substrate 10 and the second substrate 60 thus produced are bonded to each other by interposing a sealing material (sealant). Liquid crystals are enclosed between the substrates and a polarizing plate and the like are mounted. In this manner, a liquid crystal display device 200 is produced. Here, the sealing material is not particularly limited, and examples thereof include a UV-curing resin, a thermosetting resin, and the like.

The liquid crystal display device 200 according to the present embodiment produced as above has a pixel electrode 19 having a favorable pattern in the first substrate. Therefore, it is possible to suppress the variation in the alignment direction of liquid crystals around the tips of the branch portions 19b of the pixel electrode 19. This reduces a black-display region produced under voltage application. As a result, the light transmittance can be improved by about 5%. Reduction in alignment defects of liquid crystals suppresses the variation in brightness and lowering in the response speed. In addition, image display with a wide view angle can be realized.

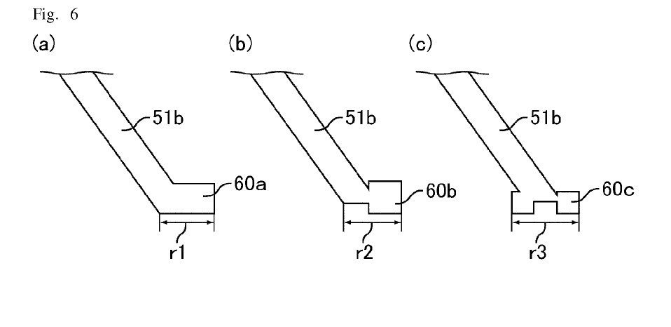

In the above description, a case where the wide parts 60 in a triangular shape are formed in the mask pattern is exemplified. However, the present invention is not limited to this, and may have wide parts 60a to 60c illustrated in FIGS. 6(a) to 6(c).

FIGS. 6(a) to 6(c) are enlarged schematic views each illustrating a principal part of another embodiment of a mask pattern according to the present embodiment. FIG. 6(a) illustrates a case where a wide part 60a in a rectangular shape is formed at the tip of the branch portion 51b and the width of the wide part 60a is r1. FIG. 6(b) illustrates a case where a wide part 60b in a rectangular shape is formed at one corner of the tip of the branch portion 51b and the width of the wide part 60b is r2. FIG. 6(c) illustrates a case where a wide part 60c in a rectangular shape is formed at two corners of the tip of the branch portion 51b and the width of the wide part 60c is r3. Such a configuration also provides an effect similar to the effect obtained in the above.

Here, the shapes of the wide parts 60a to 60c are not limited to an accurate rectangles, and may include a circular shape, a round rectangular shape, an elliptical shape, and the like. Moreover, the shape may be a rectangular shape with protrusions.

### Embodiment 2

The present embodiment is described referring to a case where a photomask having a wide part 60a as illustrated in FIG. 6(a) is used. The same symbols are attached to members having the same configurations as those shown in Embodiment 1, and the descriptions thereof are omitted.

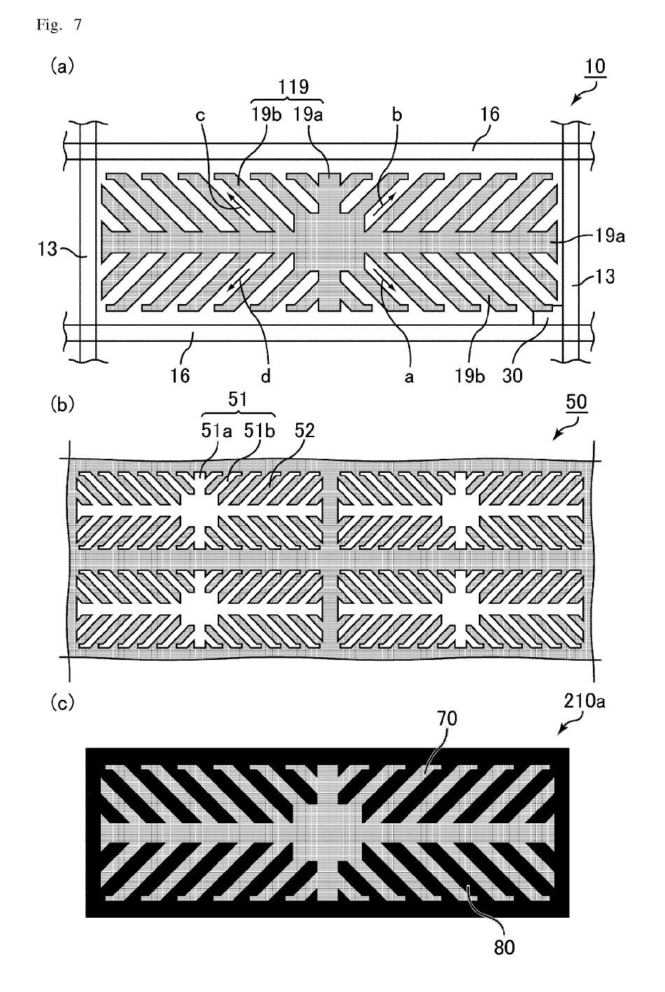

FIG. 7(a) is a schematic plan view of a pixel electrode according to the present embodiment. FIG. 7(b) is a schematic plan view of a photomask. FIG. 7(c) is a schematic plan view illustrating the liquid crystal display device in an ON state. As illustrated in FIG. 7(a), a pixel electrode 119 having a branch portion with a rectangular tip can be realized by using a photomask 51 in a shape as illustrated in FIG. 7(b). In a liquid crystal display device 210 to be obtained, a light shielding portion is reduced at tips of the pixel electrode 119 as illustrated in FIG. 7(c). Such a configuration also provides an effect similar to the effect obtained in the Embodiment 1.

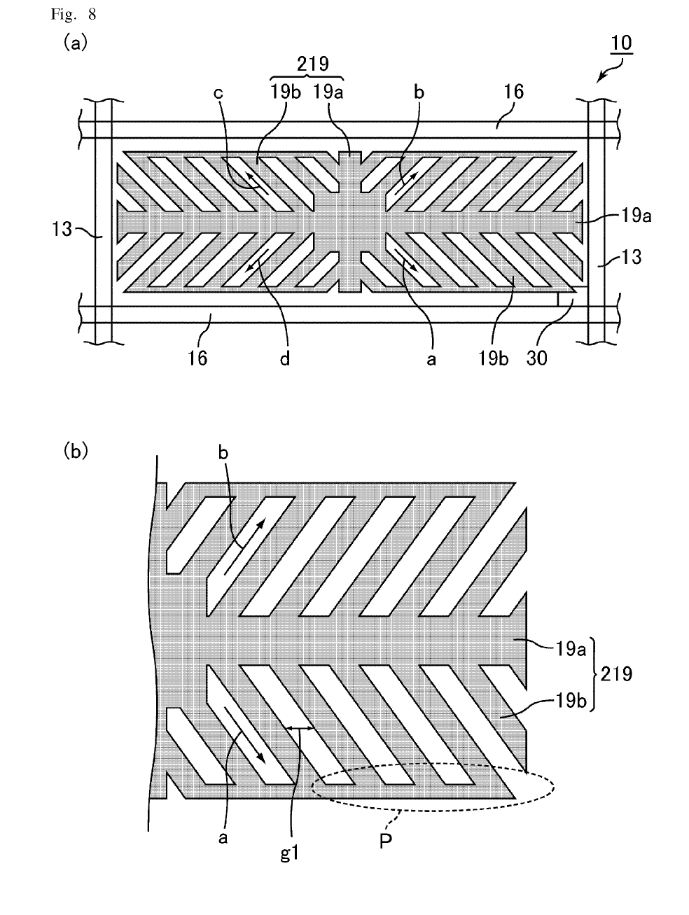

In the case that the width r1 of the wide part 60a of the photomask 51 is large, tips of the branch portions of the obtained pixel electrodes maybe combined with each other. FIG. 8(a) is a schematic plan view of the pixel electrode 219 in which the tips of the branch portions are combined. FIG. 8(b) is an enlarged schematic plan view illustrating a principal part of the pixel electrode 219 in which the tips of the branch portions are combined. In FIG. 8(b), the tips of the branch portions 19b are combined with each other as shown by a wave line P. This is a case where an interval f1 is 0 in Embodiment 1.

In such a configuration, the combined part of the tips of the branch portions 19b is a light shielding region. Therefore, the light transmittance of the liquid crystal display device is lowered compared to that of the liquid crystal display device of Embodiment 1. However, since the interval of the adjacent branch portions 19b is substantially constant from the base of the branch portion 19b to the tip of the branch portion 19b, liquid crystals are favorably aligned. This accelerates the response speed, and the display qualities are improved.

In Embodiment 1, a case where the interval g1 at the central part is narrower than the interval f1 at the tip of the adjacent branch portions 19b of the pixel electrode has been described. In Embodiment 2, a case where the tips of the adjacent branch portions 19b of the pixel electrode are combined with each other has been described. However, the interval g1 at the central part may be substantially the same as the interval f1 at the tip of the adjacent branch portions 19b. Namely, between the interval g1 at the central part and the interval fl at the tip part, a relation of (g1≧f1≧0) is established.

Here, Example and Comparative Example according to Embodiment 1 are described.

### EXAMPLES

### Example 1

In the present example, a mask having a pattern illustrated in FIGS. 5(a) and (b) is used in the exposure step. In a mask pattern 50, the width d1 of the central part of the branch portion 51b was 2.5 μm and the width d2 of the wide part 60 was 3.5 μm. The exposure conditions were set by performing experimental exposure under the condition that the mask has benchmark size of the width d1. In this way, the exposure was adjusted.

The mask pattern 50 having the above shape hardly caused diffraction defects at the tips of the branch portions 51b. Accordingly, the obtained pixel electrode 19 had the branch portions 51b with the tips in a substantially ideal shape as illustrated in FIGS. 1 and 2. A liquid crystal display device was assembled using a first substrate on which the pixel electrode 19 was formed. A voltage is applied to this liquid crystal display device to set liquid crystal display to an ON state. The obtained display state was a state as illustrated in FIG. 7.

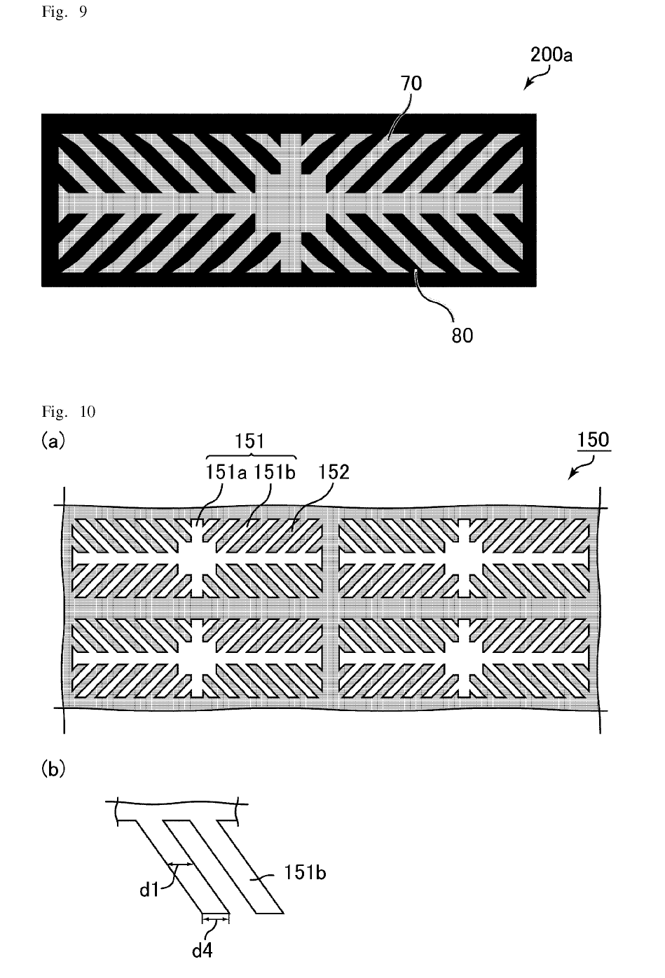

FIG. 9 is a schematic plan view illustrating a liquid crystal display device 200a according to Embodiment 1 in an ON state. In FIG. 9, the liquid crystal display device 200a has a display region 70 and a non-display region 80 in each pixel. In the liquid crystal display device 200a, the tips of the branch portions 19b of the pixel electrode 19 were not round tapered. Therefore, the alignment defect of liquid crystals hardly occurred. At the tips of the branch portions 19b of the pixel electrode 19, the non-display region 80 shown as black is small, leading to the high light transmittance.

Measurement of the light transmittance of the obtained liquid crystal display device 200a clarified that the transmittance was increased by 6.3%.

### Comparative Example 1

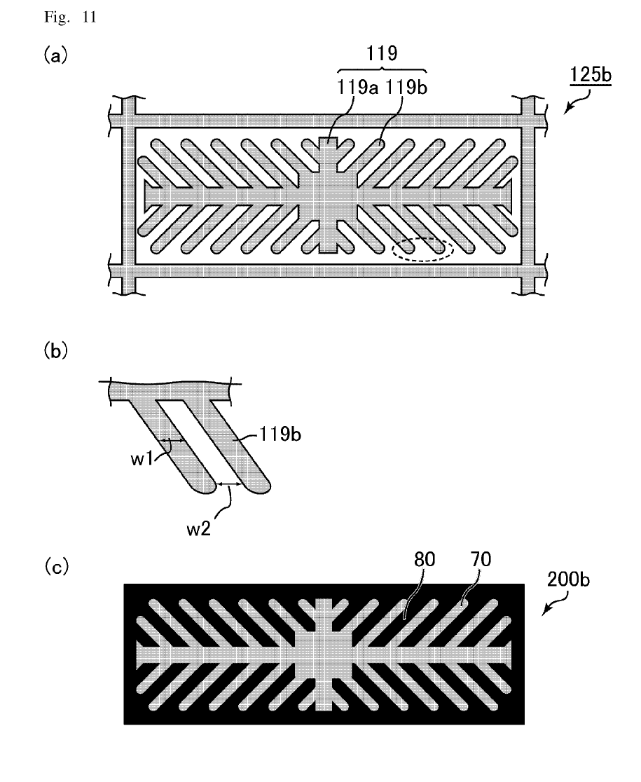

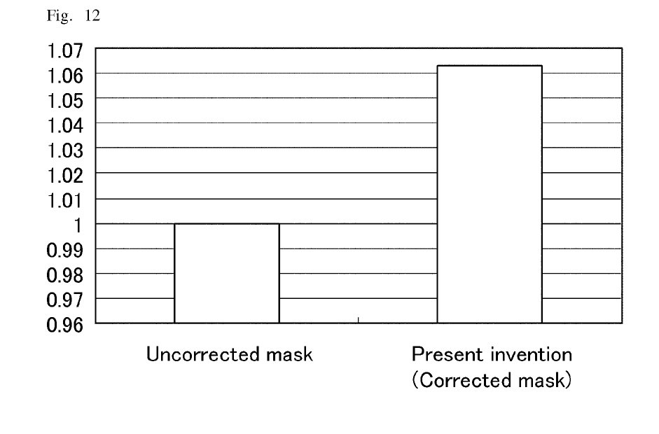

FIGS. 10 and 11 illustrate configurations of a photomask, a resist pattern, and a liquid crystal display device according to Comparative Example 1. Specifically, FIG. 10(a) is a schematic plan view of a photomask according to Comparative Example 1. FIG. 10(b) is an enlarged schematic plan view of a principal part of the photomask. FIG. 11(a) is a schematic plan view of a resist pattern. FIG. 11(b) is an enlarged schematic plan view of a principal part of the resist pattern. FIG. 11(c) is a schematic plan view illustrating the liquid crystal display device in an ON state.

In the present comparative example, tips of a mask pattern used in the exposure step were not corrected, not like the case of Embodiment 1. Except for this, a first substrate was produced in the same manner as in Example 1 and properties of an obtained liquid crystal display device were evaluated.

The exposure was performed by using a mask pattern 150 in which the pattern is formed into a desired shape without correcting the tip shape of the branch portions, as illustrated in FIG. 10(a). The mask pattern 150 had a light-transmitting portion 151 including a core portion 151a and a plurality of branch portions 151b arranged at predetermined angles relative to the direction orthogonal to the core portion 151a, and a light-shielding portion 152 between the branch portions 151b,in the same way as the mask pattern 50 illustrated in FIG. 5(a).

Here, in the branch portions 151b, the width d1 at the central part and the width d2 at the tip were the same as illustrated in FIG. 10(b).

Exposure using the mask pattern 150 having such a shape produced the branch portions with rounded tips in the resist pattern due to diffraction defects at the rectangular tip portions. The pixel electrode 119 produced using this resist pattern had the branch portions 119b with round tapered tips, as illustrated in FIGS. 11(a) and 11(b).

As illustrated in FIG. 11(c), when a voltage is applied to a liquid crystal display device 200b using a first substrate 125b to shift the liquid crystal display to the ON state, an alignment defect of liquid crystals occurred around the tips of the branch portions, resulting in frequent occurrence of areas showing black displays.

Measurement of the light transmittance of the obtained liquid crystal display device clarified that the transmittance was decreased by about 5.94% compared to that of Example 1.

Here, comparison between the liquid crystal display devices according to Embodiment 1 and Comparative Example 1 clarified that the transmittance of Example 1 was 106.3% when the transmittance of Comparative Example 1 was set to be 100%. Namely, the transmittance of Example 1 was improved. The reason for this is presumably that the black display was reduced in the tips of the branch portions of the pixel electrode.

The above Embodiments and embodiments in Examples may be employed in combination without departing from the present invention.

The present application claims priority to Patent Application No. 2009-116787 filed in Japan on May 13, 2009 under the Paris Convention and provisions of national law in a designated State, the entire contents of which are hereby incorporated by reference.

### EXPLANATION OF NUMERALS AND SYMBOLS

10 First substrate
11 Glass substrate
13 Gate signal line
15 Gate insulating film
16 Source signal line
17 Drain electrode
18 Interlayer insulating film
19 Pixel electrode
19a Core portion
19b Branch portion
20 Conductive film
25 Resist film
25a Resist pattern
30 TFT
31 Contact hole
50 Photomask
51 Light-shielding part
51a Core portion
51b Branch portion
52 Light-transmitting part
55 Light
60 Second substrate
70 Light-transmitting part
100 Liquid crystal layer
200 Liquid crystal display device
d1, d2 Width
d3 Interval between branch portions
L Virtual line along tips on long edge side of branch portions
M Intersection

1. A method for producing a liquid crystal display device comprising a pair of substrates, a liquid crystal layer between the substrates, and an electrode for voltage application in the liquid crystal layer,
the method comprising the steps of:
resist pattern formation in which a resist film formed on a conductive film is exposed through a photomask; and
an electrode pattern formation in which the conductive film is etched through the resist pattern,
the photomask having a light-shielding or light-transmitting pattern including a core portion and a plurality of branch portions extending from the core portion,
the branch portions each having a wide part at the tip.

2. The method for producing a liquid crystal display device according to claim 1,
wherein the wide part in the photomask is wider than an interval between the branch portions adjacent to each other.

3. The method for producing a liquid crystal display device according to claim 1,
wherein the wide part in the photomask has a larger area than the tip of a branch portion of the electrode obtained through the electrode pattern formation.

4. The method for producing a liquid crystal display device according to claim 1,
wherein the core portion of the light-shielding or light-transmitting pattern of the photomask has a cross shape and divides each pixel into four domains, and the plurality of branch portions extends obliquely from the core portion in each of the four domains, when seen in a normal direction of the mask face, and
an angle formed by a virtual line along the tips of the plurality of branch portions on a pixel boundary side and a short edge of the tips is within a range of 0° to 30°.

5. The method for producing a liquid crystal display device according to claim 4,
wherein the wide part is positioned within a range of 0.5 to 3 μm from an intersection between the virtual line along the tips on the pixel boundary side and an extended line of a long edge of each of the branch portions.

6. The method for producing a liquid crystal display device according to claim 1,
wherein the conductive film is a transparent conductive film, a reflective conductive film, or a lamination comprising a transparent conductive film and a reflective conductive film.

7. A liquid crystal display device comprising a first substrate, a liquid crystal layer, and a second substrate in this order,
wherein the first substrate includes a pixel electrode having a core portion and a plurality of branch portions extending from the core portion,
the pixel electrode is for applying a voltage to the liquid crystal layer, and,
an interval between the branch portions adjacent to each other at a tip part is substantially the same as or narrower than the interval at a central part of the branch portions, or the tips are combined with each other.
